(19) United States
(12) Patent Application Publication
(10) Pub. No.: US 2016/0346762 A1
(43) Pub. Date: Dec. 1, 2016

(54) CERIUM DIOXIDE NANOPARTICLES AND METHODS FOR THEIR PREPARATION AND USE

(71) Applicant: XI'AN JIAOTONG UNIVERSITY, Xi'an, Shanxi (CN)

(72) Inventors: Yongquan QU, Xi'an, Shanxi (CN); Yuanyuan MA, Xi'an, Shanxi (CN); Jing LI, Xi'an, Shanxi (CN)

(73) Assignee: XI'AN JIAOTONG UNIVERSITY, Xi'an, Shanxi (CN)

(21) Appl. No.: 15/117,395

(22) PCT Filed: Feb. 7, 2014
(86) PCT No.: PCT/CN2014/071872

§ 371 Date: Aug. 8, 2016

(51) Int. Cl. B01J 23/10; C01F 17/00; B01J 35/10; B01J 35/02; B01J 23/63; B01J 35/00

(52) U.S. Cl. CPC B01J 23/10; B01J 23/63; B01J 35/0013; B01J 35/1014; B01J 35/1019; B01J 35/026; C01F 17/0043; C01P 2004/64

(57) ABSTRACT

Nanoparticles and methods for their preparation are described. Porous CeO₂ nanoparticles may be made by contacting Ce(NO)₃ with a base to form a mixture, and converting the mixture into a composition including one or more porous CeO₂ nanoparticles. Nanoparticles may be made by contacting Ce(NO₃)₃ with a base to form a mixture including the nanoparticles. Porous CeO, nanoparticles may have a high oxygen vacancy concentration, a high specific surface area, a high oxygen storage capacity, and/or a high specific Ce⁻³⁺ ratio. The porous CeO₂ nanoparticles may he used as a co-catalyst in a catalyst system or as a catalyst carrier.

### BACKGROUND

The reversible conversion between Ce⁴⁺ and Ce³⁺ existing in the structure of fluorite CeO₂ endows CeO₂ (cerium dioxide; cerium (IV) oxide) nanomaterial with excellent oxygen storage and release performance and oxidation-reduction ability. For this reason, CeO₂ nanomaterial is widely applied in high-tech fields such as, for example, catalysts, co-catalysts, catalyst carriers, water pollution purification, ultraviolet absorbers, three-way catalysts, oxygen sensors, solid oxide fuel cells, glass polishing, and electrode materials.

For applications such as automobile exhaust treatment, Oxygen Storage Capacity (OSC) is an important parameter index for assessing catalysts. The OSC of pure CeO₂ is relatively small (less than 360 μmol/g). A common method for increasing OSC is CeO₂ doping. Doping with Zr is studied most widely at present. The OSCs of most doped CeO₂ are 500-700 μmol O₂/g. When CeO₂ serves as an active component of a catalyst, a co-catalyst, or a catalyst carrier, the control of its surface defects or acid and basic sites has a great impact on the catalytic material. Therefore, CeO₂ material with a higher OSC and controllable surface acid and basic sites is desirable.

### SUMMARY

In an embodiment, a method of making one or more porous CeO₂ nanoparticles includes contacting Ce(NO₃)₃ and a base at a pressure and temperature to form a mixture, and converting the mixture into a composition including one or more porous CeO₂ nanoparticles.

In an embodiment, a method of making one or more nanoparticles includes contacting Ce(NO₃)₃ and a base at a pressure and temperature to form a mixture comprising the one or more nanoparticles.

In an embodiment, at least one porous CeO₂ nanoparticle has high oxygen vacancy concentration, high specific surface area, high oxygen storage capacity, a high specific surface Ce³⁺ ratio, or combinations thereof.

In an embodiment, a catalyst system includes at least one first catalyst and at least one co-catalyst, wherein the co-catalyst includes at least one porous CeO₂ nanoparticle.

In an embodiment, a catalyst system includes a catalyst supported on a carrier, wherein the carrier includes at least one porous CeO₂ nanoparticle.

In an embodiment, one or more nanoparticles are prepared by a method including contacting Ce(NO₃)₃ and base at a pressure and temperature to form a mixture including one or more nanoparticles.

### BRIEF DESCRIPTION OF THE DRAWINGS

The drawings submitted herewith show some embodiments or features of some embodiments encompassed by the disclosure. The drawings are meant to be illustrative and are not intended to be limiting.

FIG. 1 shows the TEM images of the as-prepared porous CeO₂ nanorods, nonporous CeO₂ nanorods, CeO₂ nanocubes, and CeO₂ nano-octahedrons.

FIG. 2 shows the performance parameters of porous CeO₂ nanorods subjected to different treatments.

FIG. 3 shows CO oxidation performance catalyzed by porous CeO₂ nanorods.

FIG. 3(a) shows a comparison between porous CeO₂ nanorods (triangle symbols) and nonporous CeO₂ nanorods (round symbols). The x-axis is temperature in ° C. The y-axis is CO conversion in percent.

FIG. 3(b) shows CO oxidation catalyzed by nonporous CeO₂ nanorods (square symbols), cubes (round symbols), and octahedrons (triangle symbols). The x-axis is temperature in ° C. The y-axis is CO conversion in percent.

FIG. 3(c) shows CO oxidation catalyzed by porous CeO₂ nanorods treated hydrothermally at different temperatures (square symbols=120° C., round symbols=140° C., rightside up triangle symbols=160 ° C., upside down triangle symbols=180 ° C., and left facing triangle symbols=200° C.). The x-axis is temperature in ° C. The y-axis is CO conversion in percent.

FIG. 3(d) shows CO oxidation catalyzed by porous CeO₂ nanorods treated by high temperature annealing (square symbols=200° C., round symbols=300° C., rightside up triangle symbols=400° C., and upside down triangle symbols=500° C.). The x-axis is temperature in ° C. The y-axis is CO conversion in percent.

FIG. 4 shows a summary of OSC and BET surface areas of CeO₂ based nanostructures.

### DETAILED DESCRIPTION

This disclosure is not limited to the particular systems, devices, and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The described technology generally relates to nanoparticles and methods for their preparation and use. The nanoparticles may be made by contacting Ce(NO₃)₃ and a base at a pressure and temperature to form a mixture of one or more nanoparticles. This mixture can be converted into a composition including one or more porous CeO₂ nanoparticles. In some embodiments, the porous CeO₂ nanoparticles have high oxygen vacancy concentration, high specific surface area, high oxygen storage capacity, high specific surface Ce³⁺ ratio, or a combination thereof. In some embodiments, the porous CeO₂ nanoparticles are used in a catalyst system including at least one first catalyst and at least one co-catalyst, wherein the co-catalyst includes at least one porous CeO₂ nanoparticle. In some embodiments, the porous CeO₂ nanoparticles are used in a catalyst system including wherein a catalyst is supported on a carrier, and the carrier includes at least one porous CeO₂ nanoparticle.

As described herein, CeO₂ material with a higher OSC and/or controllable surface acid and basic sites is provided. The preparation of porous CeO₂ nanorods is achieved by a simple scheme in which the conventional hydrothermal method is improved. In some embodiments, the nanomaterial made according to a method described herein has a very high oxygen vacancy concentration, and therefore a high OSC. In some embodiments, the OSC is about 4 times as much as that of conventional CeO₂ nanomaterial. In some embodiments, the nanomaterial made according to a method described herein additionally has a high specific surface area and/or a high specific surface Ce³⁺ ratio. These characteristics provide CeO₂ materials produced according to methods described herein with unique advantages in oxidation reactions and/or reactions catalyzed by a Lewis Base. In some embodiments, the control of surface oxygen vacancy and Ce³⁺ concentration can be achieved by post-treatment. In some embodiments, the porous structure of the CeO₂ material has good stability while maintaining the fluorite structure as unchanged. Thus, in some embodiments, the structure will not collapse when exposed to a high temperature, for example a temperature of 600° C., for a long period of time.

Disclosed herein are nanoparticles, and methods for their preparation and use. The nanoparticles may be prepared by any method described herein. In terms of material preparation, the present method is simple and cost-effective. The chemicals needed are only low-cost cerous nitrate and sodium hydroxide. The laboratory work shows that the cost for preparing porous CeO₂ nanorods is even lower than that for preparing porous SiO₂ materials under the same laboratory conditions.

CO oxidation reactions exist in many fields of industrial production, such as automobile exhaust treatment, diesel engine exhaust treatment, purification of hydrogen fuel in proton exchange membrane fuel cells, prevention of platinum electrode of methanol fuel cells from poisoning, water-gas shift reaction, methanol synthesis, methane conversion, methanol/ethanol steam reforming for hydrogen production, and hydrocarbon reforming. Moreover, a CO oxidation reaction is often used as a probe reaction for an oxidation catalyst to reveal the relationship between catalyst performances and structure, wherein CeO₂ material is mainly applied in the form of catalyst carrier in such a reaction. Various active components, for example, noble metals such as Pt, Au, and Ru, or ion-noble metal oxides such as CuO, NiO, and Co₃O₄, can be highly dispersed in this novel porous CeO₂ nanomaterial, and the porous structure of this CeO₂ material can enhance the synergistic effect between active components and carriers; meanwhile, in combination with the good oxidation-reduction performances of this porous CeO, material, such CeO₂ material, as an active co-agent, can significantly improve the CO oxidation ability of the corresponding catalyst system, thereby effectively improving the corresponding reaction performances,

Cyclohexanone is a main raw material in the industrial production of Nylon-6 and Nylon-6,6. The demand for lowering costs and reducing energy-consumption promotes extensive research on the method for producing cyclohexanone from phenol through hydrogenation. A noble metal, for example, Pd, is loaded onto this type of porous CeO2 nanornaterial. In one aspect, the high pore density and large specific surface area can greatly stabilize the existence of the noble metal active components. In another aspect, the increase in alkalinity on the surface of such materials can also promote electron enrichment at Pd active sites.

Aldehydes and ketones are significant compounds for synthesizing fine chemicals, and they are mainly converted from the oxidation of alcohols. The excellent oxidation-reduction performances of this type of CeO2 material facilitate the direct oxidation of alcohols into aldehydes and ketones by corresponding catalysts. The porous structure can stabilize the activated active components, and meanwhile the rapid flow of oxygen on the surface is beneficial to the re-oxidation of the active components after reaction.

The production of unsaturated alcohols from α,β-unsaturated aldehydes through hydrogenation is a significant reaction for producing pharmaceuticals, agricultural chemicals and perfume compounds. C═C is a chemical bond more stable than C═O. For example, in crotonaldehyde and citral, the oxygen vacancies located at the interface between CeO₂ and active metal components can accelerate the induction of C═O bond activation due to the fact that the porous structure on the surface of this material enhances the metal-carrier interactions between CeO₂ carrier and active components.

Acetals are widely applied in the production of cosmetics, foods and flavor additives, pharmaceuticals and polymers in the form of perfume, and acetals are obtained mainly by condensation of carbonyl compounds. The Lewis-Acid sites formed by a high concentration of Ce³⁺ on the surface of this novel CeO₂ porous material can accelerate the activation of carbonyl groups by synergistic effects.

The large amount of polluted water discharged from pharmaceutical factories, chemical plants and residential areas can cause water eutrophication after it enters water body and promote abnormal growth of various aquatic organisms, so it is extremely harmful. CeO₂ material is a semiconductor itself, which, in combination with the good valence alternation feature of this novel porous structure, makes this porous material have excellent photocatalytic performances to effectively inhibit simple complexation of electron-vacancy pairs and almost non-selectively oxidize organic compounds, thus playing an important role in polluted water treatment.

The industrial waste water from dye, pharmaceutical, petrifaction and plasticizer productions comprises a large amount of phenol. This type of waste water has serious pollution to the environment, and has great toxicity to human and aquatic organisms. Low concentration of phenol can be oxidized by catalytic wet oxidation. CeO₂ material has excellent ability of oxidizing phenol, which, in combination with the low cost, good structural stability and recyclability of this novel porous structure, makes this novel CeO₂ material play an important role in the treatment of waste water containing phenol.

In some embodiments, a method of making one or more porous CeO₂ nanoparticles includes contacting Ce(NO₃)₃ and a base at a pressure and temperature to form a mixture, and converting the mixture into a composition including one or more porous CeO₂ nanoparticles.

In some embodiments, a method of making one or more nanoparticles includes contacting Ce(NO₃)₃ and a base at a pressure and temperature to form a mixture comprising one or more nanoparticles. In some embodiments, the method further comprises converting the mixture into a composition including one or more porous CeO₂ nanoparticles.

In some embodiments, at least one porous CeO₂ nanoparticle has one or more of high oxygen vacancy concentration, high specific surface area, high oxygen storage capacity, high specific surface Ce³⁺ ratio, or combinations thereof.

In some embodiments, a catalyst system includes at least one first catalyst and at least one co-catalyst, wherein the co-catalyst includes at least one porous CeO₂ nanoparticle. In some embodiments, the first catalyst may be CeO₂—ZrO₂, CeO₂—TiO₂, CeO₂—CdS, or combinations thereof.

In some embodiments, a catalyst system includes a catalyst supported on a carrier, wherein the carrier includes at least one porous CeO₂ nanoparticle. In some embodiments, the catalyst may be Pt, Au, Pd, Ni, Ru, NiO, CuO, or a combination thereof.

The nanoparticles of any of the embodiments may be prepared by any of the methods described herein.

In any of the embodiments described herein, the base may be NaOH, KOH, or combinations thereof In some embodiments, the base is NaOH.

In any of the embodiments described herein, the ratio of Ce(NO₃)₃ to base may be about 1:80 to about 1:200. In some embodiments, the ratio of Ce(NO₃)₃ to base is about 1:120.

In any of the embodiments described herein, the pressure may be about 1.0 atmospheres to about 1.5 atmospheres.

In any of the embodiments described herein the temperature may be about 100° C. In some embodiments, the temperature is 100° C.

In any of the embodiments described herein, the mixture may include at least one of CeO₂ and Ce(OH)₃. In some embodiments, the mixture includes CeO₂ and Ce(OH)₃.

In any of the embodiments described herein, the method of making nanoparticles may include washing the mixture to remove excess base after contacting Ce(NO₃)₃ and the base. In some embodiments, distilled water is used to wash the mixture. In some embodiments, the washing results in the mixture having a neutral pH value.

In any of the embodiments described herein, the method of making nanoparticles may include dispersing the mixture in a liquid. In some embodiments, the liquid includes water. In some embodiments, the liquid includes a hydrophilic solvent. In some embodiments, the liquid includes an alcohol, a ketone, N-N-dimethylformamide, or combinations thereof.

In any of the embodiments described herein, the method of making nanoparticles may include converting the mixture created by contacting Ce(NO₃)₃ and a base at a pressure and temperature into a composition including one or more porous CeO₂ nanoparticles. In some embodiments, the mixture is converted into a composition including one or more porous CeO₂ nanoparticles by dehydrating the mixture. In some embodiments, a hydrothermal method is used to dehydrate the mixture. In some embodiments, the hydrothermal method uses an autoclave. In some embodiments, the autoclave is set at a temperature of about 160 ° C. to about 200° C. In some embodiments, the autoclave is set at a temperature of about 160 ° C. In some embodiments, the mixture is in the autoclave for about 12 hours to about 24 hours. In some embodiments, the mixture is in the autoclave for about 12 hours. In some embodiments, the mixture is converted into a composition comprising one or more porous CeO₂ nanoparticles by calcination. In some embodiments, the calcination occurs at a temperature of about 200° C. to about 600° C. In some embodiments, the calcination occurs at a temperature of about 300° C.

Any of the foregoing embodiments may be used to make the nanoparticles described herein.

In any of the embodiments described herein, the nanoparticles may be a mixture of CeO₂ and Ce(OH)₃. In some embodiments, the nanoparticles are substantially CeO₂. In some embodiments, the nanoparticles are CeO₂. In some embodiments, the nanoparticles have an average length of about 40 nm to about 80 mm. In some embodiments, the nanoparticles have an average diameter of about 5 nm to about 8 nm. In some embodiments, the nanoparticles are rod-shaped. In some embodiments, the nanoparticles are porous. In some embodiments, the nanoparticles are non-porous.

In any of the embodiments described herein, the nanoparticles may be porous CeO₂ nanoparticles. In some embodiments, the porous CeO₂ nanoparticles have an average length of about 40 nm to about 80 nm. In some embodiments, the porous CeO₂ nanoparticles have an average diameter of about: 5 nm to about 8 nm. In some embodiments, the porous CeO₂ nanoparticles have one or more of high oxygen vacancy concentration, high specific surface area, high oxygen storage capacity, high specific surface Ce³⁺ ratio, or combinations thereof In some embodiments, the porous CeO₂ nanoparticles may have an oxygen vacancy concentration that is larger than the oxygen vacancy concentration of nonporous CeO₂ nanoparticles. In some embodiments, the porous CeO₂ nanoparticle may have a specific surface area of at least about 95 m²/g. In some embodiments, the porous CeO₂ nanoparticle may have a specific surface area of 95 m²/g to 150 m²/g, In some embodiments, the porous CeO₂ nanoparticles have a specific surface area of about 100 m²/g to about 150 m²/g. In some embodiments, the porous CeO₂ nanoparticles have a specific surface area of about 95 m²/g, about 100 m²/g, about 105 m²/g, about 141 m²/g, or about 150 m²/g, or any number between any of these values, or any range of numbers between any of these values or beginning or ending with any of these values, inclusive. In some embodiments, the porous CeO₂ nanoparticles may have an oxygen storage capacity of at least about 700 μmol O₂/g. In some embodiments, the porous CeO₂ nanoparticles may have an oxygen storage capacity of about 700 μmol O₂/g to about 900 μmol O₂/g. In some embodiments, the porous CeO₂ nanoparticles may have an oxygen storage capacity of about 800 μmol O₂/g to about 900 μmol O₂/g. In some embodiments, the porous CeO₂ nanoparticles may have an oxygen storage capacity of about 900 μmol O₂/g. In some embodiments, the porous CeO₂ nanoparticles may have an oxygen storage capacity of about 700 μmol O₂/g, about 715 μmol O₂/g, about 800 μmol O₂/g, about 840 μmol O₂/g, or about 900 μmol O₂/g, or any number between any of these values, or any range of numbers between any of these values or beginning or ending with any of these values, inclusive. In some embodiments, the porous CeO₂ nanoparticles may have a specific surface Ce of at least about 9%. In some embodiments, the porous CeO₂ nanoparticles may have a specific surface Ce³⁺ ratio of about 9% to about 33 ° .4 In some embodiments, the porous CeO₂ nanoparticles may have a specific surface Ce³⁺ ratio of about 9% to about 21%. In some embodiments, the porous CeO₂ nanoparticles may have a specific surface Ce³⁺ ratio of about 19% to about 33%. In some embodiments, the porous CeO₂ nanoparticles may have a specific surface Ce³ ratio of about 9%, about 9.21%, about 19%, about 21%, about 30.8%, or about 33%, or any number between any of these values, or any range of numbers between any of these values or beginning or ending with any of these values, inclusive.

In any of the embodiments described herein, there may be at least one active component dispersed in the porous CeO₂ nanoparticles. In some embodiments, the active component may be at least one noble metal, at least one metal oxide, at least one bi-metal, at least one triple-metal, or combinations thereof In some embodiments, the noble metal may be ruthenium, rhodium, palladium, osmium, iridium, platinum, gold, mercury, rhenium, silver, copper, or combinations thereof. In some embodiments, the metal oxide may be CuO, NiO, Co₃O₄, or combinations thereof. In some embodiments, the hi-metal may be PtPd, AuPd, or combinations thereof. In some embodiments, the hi-metal may be two metals selected from Ni, Co, Au, Ag, Cu, Fe, Pt, Pd, Rh, Ru, and Ir. In some embodiments, the triple-metal may be CoNiPt, CuPdAu, or combinations thereof. In some embodiments, the triple-metal may be three metals selected from Ni, Co, Au, Ag, Cu, Fe, Pt, Pd, Rh, Ru, and Ir.

### EXAMPLES

### Example 1

### Material Synthesis

Porous CeO₂ nanorods were synthesized by a two-step hydrothermal method. The amount of the Ce³⁺ in the precursor and the pressure aid in the reaction of producing precursors. The two-step hydrothermal method includes first mixing Ce(NO₃)₃ and NaOH to obtain the rod-shaped precursor nanostructures of a mixture of Ce(OH)₃ and CeO₂. The pressure of this step was controlled between 1 atm and 1.5 atm. At the end of this step, any excess NaOH was washed off. Secondly, the mixture was dehydrated to obtain the porous CeO₂ nanorods through either the second hydrothermal treatments or high temperature calcination. A reactor was designed to precisely control the reaction conditions of the first step in the low pressure regime. The pressure control in the first-step hydrothermal process aids in producing the porous CeO₂ with high surface area and high OSC.

### Example 2

### Material Characterization/Performances

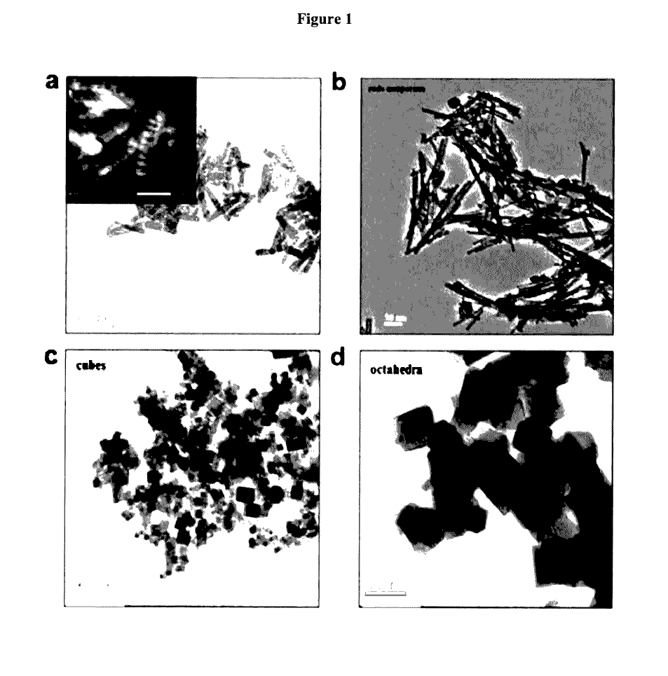

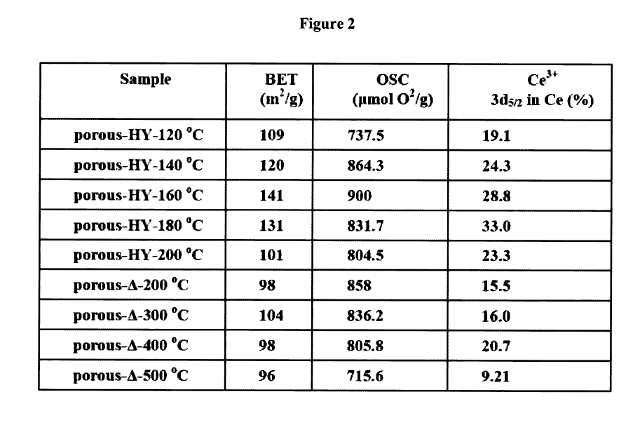

FIG. 1 shows the TEM images of the as-prepared porous CeO₂ nanorods, nonporous CeO₂ nanorods, CeO₂ nanocubes, and CeO₂ nano-octahedrons. The basic performances of the materials were characterized by various methods. The specific data are listed in the table in FIG. 2. The specific surface area measurement was conducted on ASAP 2020 (Micromeritics, Inc.; Norcross, Ga., USA). The OSC was measured by using CHEMBET-3000 (Quantachrome, Inc.; Boynton Beach, Fla., USA). The surface Ce³⁺ ratio was obtained by XPS (Thermo Scientific K-Alpha; Thermo Fisher Scientific; Waltham, Mass., USA), It can be seen from the table that the porous CeO₂ nanorods obtained from either hydrothermal treatment (HY) or high-temperature calcination (delta symbol) have very high specific surface area (BET), wherein the porous CeO₂ nanorods hydrothermally treated at 160° C. have the highest specific surface area (141 m²/g), the highest OSC, and the highest surface Ce³ ratio. In terms of hydrothermal treatment and high-temperature calcination schemes, the porous CeO₂ nanorods obtained from the hydrothermal treatment have a larger specific surface area, a higher OSC and a. higher surface Ce³⁺ ratio. The assays of these performances were achieved by repeating the measurements many times. This means that the surface performances of the porous CeO₂ nanorods obtained by the herein described method can become controllable by treatments. This provides a good research platform for regulating catalytic materials and reactions. Based on this, CO oxidation reaction (the main reaction in automobile exhaust treatment) was used as a characterization reaction to verify the catalytic activity of the porous CeO₂ nanorods.

To verify the catalytic activity of the as-prepared porous CeO₂ nanorods, nonporous CeO₂ nanorods, CeO₂ nanocubes and CeO₂ nano-octahedrons were also prepared for comparative experiments. All the experiments were carried out under the same catalytic conditions. Specific catalytic parameters are as follows:

A quartz reactor with an inner diameter of 4 mm was filled with 250 mg of a catalyst with a particle size of 60-100 mesh in the middle section. Both ends of the reactor bed were blocked with silica wool. Then, a K-shape thermocouple was placed at the middle of the catalyst bed. After filling, a reaction gas, which consists of 1% O₂, 1% CO and a balance of Ar, was charged at a flow rate of 50 ml/min.

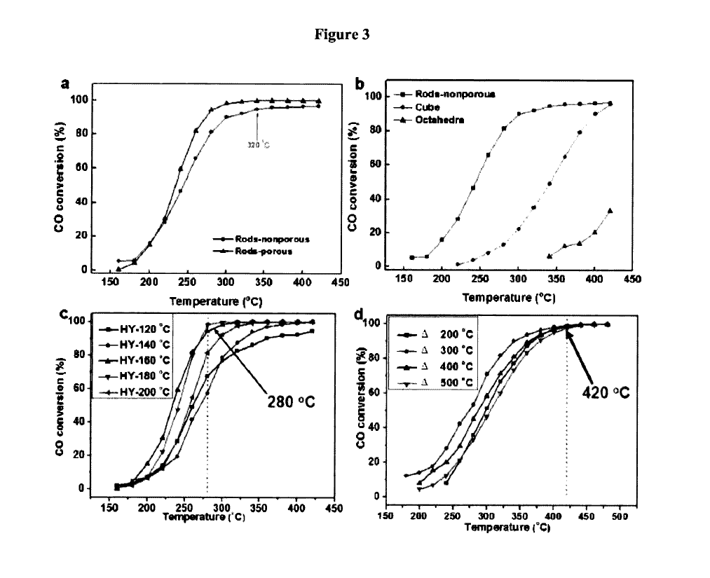

The catalysis results are shown in FIG. 3. In terms of the catalytic performances of the nonporous and porous CeO₂ nanorods, the porous CeO₂ nanorods hydrothermally treated at 160° C. oxidized CO into CO₂ completely at 320° C., whereas the nonporous CeO₂ nanorods could not oxidize 99% CO into CO₂ until the temperature reached about 420 C. in addition, the CeO₂ nanocubes completely oxidized CO at a temperature above 420° C., while the CeO₂ nano-octahedrons only converted 33% CO at 420° C. The oxidation catalytic performances of the nonporous CeO₂ nanorods, CeO₂ nanocubes and CeO₂ nano-octahedrons were in accordance with those reported in the prior references, It is demonstrated that the porous CeO₂ nanorods prepared by the herein described method have very high catalytic activity in oxidizing CO. The enhanced catalytic activity is mainly derived from the unique performance of high OSC of the porous CeO₂ nanorods.

The CO oxidation catalytic performances of the porous CeO₂ nanorods subjected to different treatments were also compared. FIG. 3(c) shows the catalytic performances of the porous CeO₂ nanorods subjected to hydrothermal treatment. It can be seen from the figure that the nanorods hydrothermally treated at 160° C. and 180° C. have the highest CO oxidation catalytic performances. The porous CeO₂ nanorods hydrothermally treated at 180° C. completely oxidize CO at 280° C., which is in accordance with the results of OSC and specific surface area of the catalyst. However, the catalytic performances of the porous CeO₂ nanorods subjected to high-temperature calcination are inferior to those of the porous CeO₂ nanorods subjected to hydrothermal treatment. For the calcinated samples, the catalytic performances are different at the initial stage, but CO is almost completely oxidized at 420° C. In terms of the two treatment methods, the porous CeO₂ nanorods subjected to hydrothermal treatment (at 160° C. and 180° C.) have reduced the temperature at which CO is completely oxidized by 140° C. This demonstrates the superior catalytic performances of the porous CeO₂ nanorods subjected to hydrothermal treatment.

Due to high OSC, high specific surface area and controllable surface performances, porous CeO₂ nanorods can be widely applied in many catalytic reactions, such as organic reactions catalyzed by Lewis acid-base under research, WGS reactions, steam reforming of CH₄ and dry reforming of methane. Great progress has been made in laboratories for dry reforming of methane (DRM). DRM is a significant reaction in which CO, is reused to produce CO and H₂ under catalysis, and it can also achieve the objective of reducing problematic gases CO, and CH₄. However, this reaction is an endothermic reaction and usually occurs at 500-800° C. The existing main problems of this reaction are thermal stability of metal catalyst carrier, high-temperature agglomeration of metal catalyst on carrier surface, carbon deposition and inhibition of side reactions. The experiments show that the CeO₂ nanorods have advantages in stabilizing metal catalysts, inhibiting RWGS reactions and carbon deposition. The catalytic performance of 3% loaded Pt/Porous CeO₂ nanorods was reduced by only 4% in a 72 hour continuous reaction at a reaction temperature of 800° C. The carbon weight percentage of the carbon in the catalysts after 72 hours continuous reaction was determined to be only 0.3 wt % by the thermogravimetric analysis, indicating the remarkable ability of the catalysts to prevent the carbon deposition during the DRM reactions.

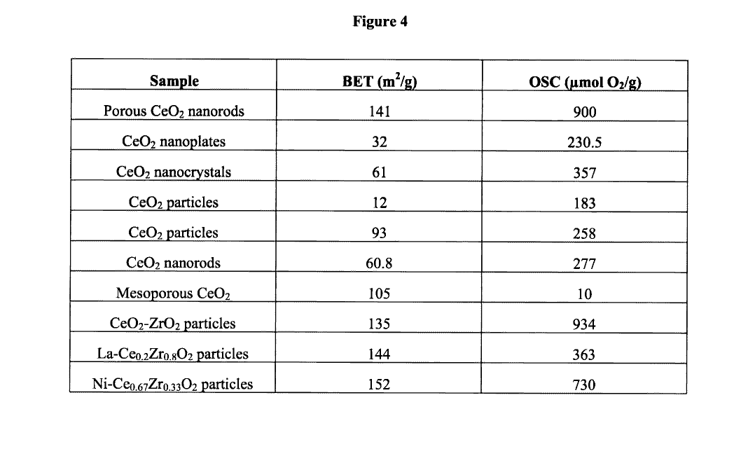

improvement in OSC and regulation of surface performance of CeO₂ material as a catalytic material carrier, a co-catalyst and an active component has always been of considerable research interest. Preparation methods can radically determine the performance parameters of the materials and demonstrate their performances. In previous studies, the maximum OSC of pure CeO₂ nanostructure can reach 357 μmol/g. A common method is to introduce Zr into CeO₂ materials, The addition of Zr can not only increase the activity of oxygen in CeO₂, improve the bulk phase characteristics of CeO₂, reduce the reduction temperature of Ce⁴⁺ and enhance the thermal stability, but also significantly improve the oxygen storage capability of the catalyst. Currently, the OSCs of Zr-doped CeO₂ reported in references are typically less than 750 μmol/g. Only one reference reports that the OSC of CeO₂ has reached 930 μmol/g (see FIG. 4). The CeO₂ nanostructures as well as their OSCs and specific surface areas after doping as reported in references are summarized in the table in FIG. 4.

The specific surface area of the as-prepared porous CeO₂ nanorods is not the largest. However, the porous CeO₂ nanorods have very good themostability. In the research results on Zr-doped CeO₂, although the initial specific surface area of the sample CZ14 (281 m²/g) is larger than that of the porous CeO₂ nanorods as prepared by methods disclosed herein, the specific surface area of CZ14 dramatically decreases to 66 m²/g after being calcinated at 500° C., while the specific surface area of the porous CeO₂ nanorods as prepared by methods disclosed herein can still be 96 m²/g after being calcinated at 500° C. for 4 hours, with a slight decrease. Additionally, the sample CZ14 only has an OSC of 104.5 μmol O²/g at 500° C., while the porous CeO₂ nanorods as prepared by methods disclosed herein have an OSC as high as 715.6 μmol O²/g even after treatment at 500° C. In further comparison of catalytic performances, the CO oxidation ignition temperature T₅₀ (defined as the temperature at which 50% of CO is converted into CO₂) of the sample CZ14 is at least higher than 390° C., while the T₅₀ of the porous CeO₂ material as prepared by methods disclosed herein is only 230° C.

### Example 3

### Treatment of Automobile Exhaust

Porous CeO₂ nanorods are synthesized by the two-step hydrothermal method described in Example 1 and placed in an automobile exhaust system. In the system, the porous CeO₂ nanorods are exposed to exhaust from the engine combustion. Exhaust gases are allowed to contact the porous CeO₂ nanorods, thereby oxidizing CO to CO₂.

### Example 4

### Treatment of Diesel Engine Exhaust

Porous CeO₂ nanorods are synthesized by the two-step hydrothermal method described in Example 1 and placed in a diesel engine exhaust system. In the system, the porous CeO₂ nanorods are exposed to exhaust from the engine combustion. Exhaust gases are allowed to contact the porous CeO₂ nanorods, thereby oxidizing CO to CO₂. Generally, the thermal. stability of the catalysts is important for this purpose since the reaction is performed at high temperatures. Herein, the thermal stability of the porous CeO₂ nanorods with a surface area of 141 m²/g and the nonporous CeO₂ nanorods were examined at high temperatures. After 600° C. calcination in air for 4 hours, 84.4% and 77.2% surface areas were preserved for the porous and nonporous CeO₂ nanorods. Raising the temperature to 800° C., the surface area of the porous CeO₂ nanorods maintained 61% of that of as synthesized. In contrast, only 29% of surface area was obtained for the nonporous CeO₂ nanorods. The results indicated the excellent thermal stability of the porous CeO₂ nanorods, which have promising applications for many high temperature processes including the treatments on the diesel engine exhaust.

### Example 5

### Production of Cyclohexanone from Phenol through Hydrogenation

Porous CeO₂ nanorods are synthesized by the two-step hydrothermal method described in Example 1. The noble metal Pd is loaded onto the porous CeO₂ nanorods. Since porous CeO₂ nanorods with a stronger basicity, they are very suitable as the support for palladium nanoparticles and enhance the capacity activity. The strong interaction between Pd nanocatalysts and porous COD, nanorods with strong basicity can significantly increase the stability of the Pd nanoparticles. Moreover, the feature of the strong basicity of the porous COD₂ nanorods will provide more electrons to Pd nanoparticles and hence increase catalytic activity for converting phenol to cyclohexanone. The high Ce³⁺ fraction of the porous CeO, nanorods favors the nonplanar-adsorption of the phenol on the surface of the catalysts and will increase the selectivity of the products to cyclohexanone. The reaction could be performed in gas-phase or liquid phase using ethanol as the solvent.

### Example 6

### Water Pollution Treatment

Porous CeO₂ nanorods are synthesized by the two-step hydrothermal method described in Example 1. A phenol-containing waste stream is allowed to flow through or over the porous CeO₂ nanorods. The porous CeO₂ nanorods oxidize the phenolic compounds. Thus, harmful organic compounds are oxidized, thereby reducing the pollution in the waste stream.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

In the above detailed description, reference is made to the accompanying drawings, which form a part hereof. In the drawings, similar symbols typically identify similar components, unless context dictates otherwise, The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductor_{y}⁻ phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “ a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “ a system having at least one of A, B, or C” would include but not be limited to systems that have A alone, B alone, C alone, A and B together, A and C together, B and C together, and/or A, B, and C together, et cetera). It wilt be further understood by those within the art that virtually any disjunctive word and/or phrase presenting two or more alternative terms, whether in the description, claims, or drawings, should be understood to contemplate the possibilities of including one of the terms, either Of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

1671 As will be understood by one skilled in the art, for any and all purposes, such as in terms of providing a written description, all ranges disclosed herein also encompass any and all possible subranges and combinations of stibrariges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled the art, a range includes each individual member. Thus, for example, a group having 1-3 cells refers to groups having 1, 2, or 3 cells. Similarly, a group having 1-5 cells refers to groups having I, 2, 3, 4, or 5 cells, and so forth.

The following terms shall have, for the purposes of this document, the respective meanings set forth below.

As used herein, “a neutral pH value” refers to a pH of around 7.

As used herein, “a hydrothermal method” refers to a method of synthesis of materials that depends on the solubility of precursors in hot water under high pressure.

As used herein, “oxygen vacancy concentration” refers to the concentration of a special class of point defects of oxide materials, in which the lattice oxygen is missed from the bulk and two trapped electrons localizes in the cavity center.

As used herein, “specific surface area” refers to a property of solids which is the total surface area of a material per unit of massy.

As used herein, “oxygen storage capacity” refers to a value that allows for the evaluation of the ability of a material to store oxygen.

As used herein, “specific surface Ce ratio” refers to n_{Ce+}/(n_{Ce3+}+n_{Ce4+}).

As used herein, “noble metal” refers to a metal that is resistant to corrosion. and oxidation in moist air. Noble metals include, but are not limited to, ruthenium, rhodium, palladium, osmium, iridium, platinum, gold, mercury, and rhenium.

As used herein, “metal oxide” refers to a chemical compound that contains at least one oxygen atom and at least one metal in its chemical formula.

As used herein, “bimetal” refers to a compound containing two distinct metals, including alloys.

As used herein, “triple-metal” refers to a compound containing three distinct metals, including alloys.

As used herein, “calcination” refers to a thermal treatment process in the presence of air or oxygen applied to a solid material to bring about a thermal decomposition, phase transition, or removal of a volatile fraction.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

(canceled)

2. A method of making one or more nanoparticles, the method comprising:
contacting Ce(NO₃)₃ and a base at a pressure and temperature to form a mixture comprising the one or more nanoparticles.

3. The method of claim 2, further comprising converting the mixture into a composition comprising one or more porous CeO₂ nanoparticles.

4. The method of claim 2, wherein contacting comprises contacting with NaOH, KOH, or combinations thereof.

5. (canceled)

6. The method of claim 2, wherein contacting comprises contacting at a ratio of Ce(NO₃)₃ to base of about 1:80 to about 1:200.

(canceled)

8. The method of claim 2, wherein the contacting comprises contacting at a pressure of about 1.0 atmospheres to about 1.5 atmospheres.

9. The method of claim 2, wherein the contacting comprises contacting at a temperature of about 100° C.

10.-12. (canceled)

13. The method of claim 2, wherein contacting results in forming one or more nanoparticles comprising CeO₂ and Ce(OH)₃.

14. The method of claim 2, wherein contacting results in forming one or more nanoparticles having an average length of about 40 nm to about 80 nm and an average diameter of about 5 nm to about 8 nm.

15.-16. (canceled)

17. The method of claim 2, wherein contacting result in forming one or more non-porous nanoparticles.

18. The method of claim 2, further comprising:
washing the mixture to remove excess base after contacting Ce(NO₃)₃ and the base.

19. (canceled)

20. The method of claim 18, wherein the washing results in the mixture having a neutral pH value.

21.-24. (canceled)

25. The method of claim 3, converting the mixture comprises dehydration.

26. The method of claim 25, wherein dehydrating comprises dehydrating by a hydrothermal method.

27.-31. (canceled)

32. The method of claim 3, wherein converting the mixture comprises calcining.

33. The method of claim 32, wherein calcining comprises calcining at a temperature of about 200° C. to about 600° C.

34.-37. (canceled)

38. The method of claim 3, wherein the converting the mixture comprises forming a mixture including one or more porous CeO₂ nanoparticles have having an oxygen vacancy concentration that is larger than the oxygen vacancy concentration of nonporous CeO₂ nanoparticles.

39. The method of claim 3, wherein converting the mixture comprises forming a mixture including one or more porous CeO₂ nanoparticles have having a specific surface area of at least about 95 m²/g.

40.-41. (canceled)

42. The method of claim 3, wherein the converting the mixture comprises forming a mixture including one or more porous CeO₂ nanoparticles have having an oxygen storage capacity of at least about 700 μmol O₂/g.

43. The method of claim 3, wherein the converting the mixture comprises forming a mixture including one or more porous CeO₂ nanoparticles have having an oxygen storage capacity of about 700 μmol O₂/g to about 900 μmol O₂/g.

44.-45. (canceled)

46. The method of claim 3, wherein converting the mixture comprises forming a mixture including one or more porous CeO₂ nanoparticles having a specific surface Ce³⁺ ratio of at least about 9%.

47.-49. (canceled)

50. The method of claim 3, further comprising dispersing at least one active component in the composition.

51. The method of claim 50, wherein dispersing comprises dispersing-at least one noble metal, at least one metal oxide, at least one bi-metal, at least one triple-metal, or combinations thereof.

52.-57. (canceled)

58. At least one A porous CeO₂ nanoparticle having one or more of comprising one or more of:
an oxygen vacancy concentration exceeding the oxygen vacancy concentration of a nonporous CeO₂ nanoparticle;
a specific surface area of at least about 95 m²/g;
an oxygen storage capacity of at least about 700 μmol O₂/g; and
a specific surface Ce³⁺ ratio of at least about 9%.

59.-60 (canceled)

61. The porous CeO₂ nanoparticle of claim 58, wherein the at least one porous CeO₂ nanoparticle has a specific surface area of about 95 m²/g to about 150 m²/g.

62.-63. (canceled)

64. The at least one porous CeO₂ nanoparticle of claim 58, wherein the at least one porous CeO₂ nanoparticle has an oxygen storage capacity of about 700 μmol O₂/g to about 900 μmol O₂/g.

65.-67. (canceled)

68. The porous CeO₂ nanoparticle of claim 58, wherein the porous CeO₂ nanoparticle has a specific surface Ce³⁺ ratio of about 9% to about 33%.

69. The porous CeO₂ nanoparticle of claim 58, wherein the porous CeO₂ nanoparticle has a specific surface Ce³⁺ ratio of about 30.8%.

70. (canceled)

71. The porous CeO₂ nanoparticle of claim 58, further comprising at least one active component.

72. The porous CeO₂ nanoparticle of claim 71, wherein the at least one active component comprises at least one noble metal, at least one metal oxide, at least one bi-metal, at least one triple-metal, or combinations thereof

73. The porous CeO₂ nanoparticle of claim 72, wherein the at least one noble metal comprises ruthenium, rhodium, palladium, osmium, iridium, platinum, gold, mercury, rhenium, silver, copper, or combinations thereof

74. The porous CeO₂ nanoparticle of claim 72, wherein the at least one metal oxide comprises CuO, NiO, Co₃O₄, or combinations thereof.

75. The porous CeO₂ nanoparticle of claim 72, wherein the at least one bi-metal comprises PtPd, AuPd, or combinations thereof.

76. The porous CeO₂ nanoparticle of claim 72, wherein the at least one bi-metal comprises two metals selected from Ni, Co, Au, Ag, Cu, Fe, Pt, Pd, Rh, Ru, and Ir.

77. The porous CeO₂ nanoparticle of claim 72, wherein the at least one triple-metal comprises CoNiPt, CuPdAu, or combinations thereof

78. The porous CeO₂ nanoparticle of claim 72, wherein the at least one triple-metal comprises three metals selected from Ni, Co, Au, Ag, Cu, Fe, Pt, Pd, Rh, Ru, and Ir.

79.-162 (canceled)
